(19) United States
(12) Patent Application Publication
(10) Pub. No.: US 2008/0025296 A1
(43) Pub. Date: Jan. 31, 2008

(54) Conditional Selection Adder and Method of Conditional Selection Adding

(75) Inventor: Kwang-Ju Lee, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/769,016

(22) Filed: Jun. 27, 2007

(30) Foreign Application Priority Data
Jul. 31, 2006 (KR) 2006-71890

(51) Int. Cl. H04L 12/50

(52) U.S. Cl. 370/358

(57) ABSTRACT

Conditional selection adders include first and second signal generators and a summation circuit. The first signal generator is configured to generate a carry generation signal and a carry propagation signal in response to a pair of operands to be added. The second signal generator is configured to generate a carry input signal and a block carry signal in response to the carry generation signal and the carry propagation signal. This second signal generator includes a plurality of groups of leaf-cells arranged in ascending order from a first group containing the fewest number of leaf-cells to a second group containing a largest number of leaf-cells. The summation circuit is configured to generate a sum of the pair of operands in response to the block carry signal, the carry propagation signal and the carry input signal. The summation circuit may include a group bypass circuit and a summation unit.

### REFERENCE TO PRIORITY APPLICATION

This application claims priority from Korean Patent Application No. 2006-71890, filed Jul. 31, 2006, the disclosure of which is hereby incorporated herein by reference.

### FIELD OF THE INVENTION

The present invention relates to integrated circuit devices and, more particularly, to binary adders used in integrated circuit devices.

### BACKGROUND OF THE INVENTION

Semiconductor integrated circuits (IC) may be divided into standard ICs and application specific integrated circuits (ASIC). The ASIC is manufactured for a specific use based on customer requests. A full-custom IC is designed and manufactured into a final chip according to the user request. A half-custom IC includes a standard-cell and a gate array that are previously manufactured and a desired logic circuit is formed by routing interconnects on the gate array.

Additionally, various ICs may be manufactured such that the manufactured IC has parameters, such as a bit width, that are suitable for a user request by placing and routing leaf-cells that are previously prepared according to a compiled macro cell library of a ASIC library. Thus, the leaf-cells should be properly defined, in order that the compiled macro cell may have a high performance regarding speed, power, area, and flexibility. The compiled macro cell may be reconstructed to an arithmetic and logic unit (ALU) by converting the leaf-cells. The leaf-cell definition is affected by an algorithm that is used for circuit implementation.

An adder is generally implemented by using a ripple carry algorithm, a carry look-ahead algorithm, or other conventional algorithm. A ripple carry adder implemented by using the ripple carry algorithm outputs a final sum result by sequentially calculating a carry bit from a least significant bit (LSB) to a most significant bit (MSB) to add two N-bit inputs in parallel. Each stage uses a carry input that is generated from a previous state, at a current stage. For example, 16-bit unit delay occurs in the ripple carry adder when an adding operation of two 16-bit inputs is performed.

A carry look-ahead adder implemented by using the carry look-ahead algorithm outputs a final sum result by grouping leaf-cells that are included in the adder to calculate carry bits at the same time, in order to improve speed of the adder by reducing delay that occurs in the adder. However, the adder size increases when the number of bits increases.

### SUMMARY OF THE INVENTION

Conditional selection adders according to embodiments of the present invention include first and second signal generators and a summation circuit. The first signal generator is configured to generate a carry generation signal and a carry propagation signal in response to a pair of operands to be added. The second signal generator is configured to generate a carry input signal and a block carry signal in response to the carry generation signal and the carry propagation signal. This second signal generator includes a plurality of groups of leaf-cells arranged in ascending order from a first group containing the fewest number of leaf-cells to a second group containing a largest number of leaf-cells. This second group may be an intermediate group of leaf-cells or a last group of leaf-cells if the order ascends monotonically from the first group to the last group. The summation circuit is configured to generate a sum of the pair of operands in response to the block carry signal, the carry propagation signal and the carry input signal. According to some of these embodiments, the summation circuit includes a group bypass circuit and a summation unit. The group bypass circuit is configured to generate a carry output signal in response to the block carry signal and the carry propagation signal. The summation unit is configured to generate a summation output signal in response to the carry input signal and the carry propagation signal. The summation output signal and the carry output signal collectively represent the sum of the pair of operands provided to the first signal generator.

According to additional embodiments of the present invention, each of the leaf-cells in the plurality of groups of leaf-cells is responsive to corresponding bits of the carry generation and carry propagation signals. Moreover, a most significant leaf-cell in each of the plurality of groups of leaf-cells is configured to generate a corresponding bit of the block carry signal. The group bypass circuit may also include a plurality of leaf-cells therein that are each configured to receive a corresponding bit of the block carry signal generated by a corresponding most significant leaf-cell.

### BRIEF DESCRIPTION OF THE DRAWINGS

FIG. 1 is a block diagram illustrating a conditional selection adder according to an example embodiment of the present invention.

FIG. 2 is a diagram illustrating leaf-cells in a carry generating unit and block leaf-cells in a group bypassing unit of the conditional selection adder of FIG. 1, according to an example embodiment of the present invention.

FIG. 3 is a diagram illustrating leaf-cells in a carry generating unit and block leaf-cells in a group bypassing unit of an adder that are to be compared with the conditional selection adder of FIG. 1.

FIG. 4A is a flow chart illustrating how the leaf-cells are grouped in the carry generating unit in FIG. 2.

FIG. 4B is a flow chart illustrating how a remainder group that includes remainder leaf-cells is arranged in the carry generating unit in FIG. 2.

FIG. 5A is a flow chart illustrating how the leaf-cells are grouped in the carry generating unit in FIG. 3.

FIG. 5B is a flow chart illustrating how a remainder group that includes remainder leaf-cells is arranged in the carry generating unit in FIG. 3.

FIG. 6 is a diagram illustrating leaf-cells in a carry generating unit and block leaf-cells in a group bypassing unit of an adder, in which a remainder group that includes remainder leaf-cells is arranged next the last group, that are to be compared with the conditional selection adder of FIG. 1.

FIG. 7 is a table illustrating a comparison result of a first gate delay for a block carry BC, a second gate delay for a carry output COUT, a third gate delay for a sum output SOUT, and a data skew, when leaf-cells in a carry generating unit are grouped using various methods.

### DESCRIPTION OF THE EMBODIMENT

Embodiments of the present invention now will be described more fully with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The technology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

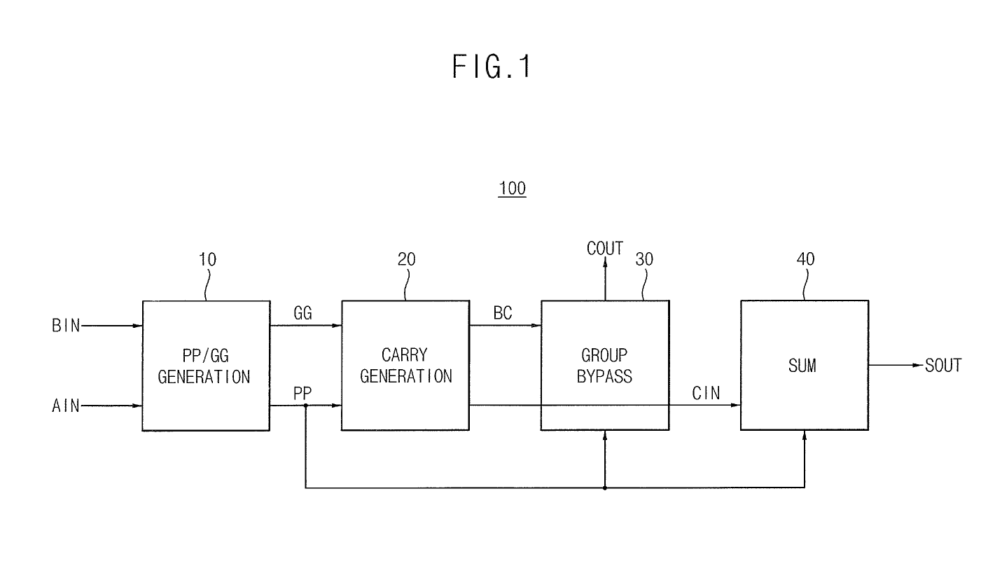

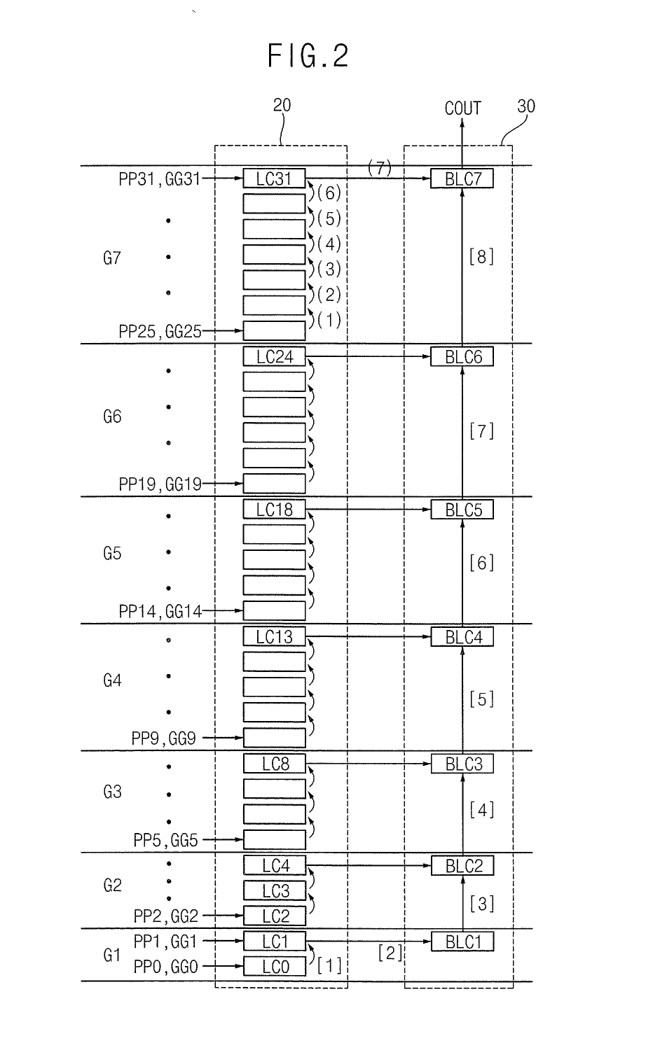

FIG. 1 is a block diagram illustrating a conditional selection adder I 00 according to an example embodiment of the present invention. Referring to FIG. 1, a conditional selection adder 100 includes a carry signal generating unit 10, a carry generating unit 20, a group bypassing unit 30, and a summing unit 40. The carry signal generating unit 10 generates a carry generation signal GG and a carry propagation signal PP based on two N-bit inputs. Here, the number N may be one of 4, 8, 16, 32, 64, and 128, for example. The carry generating unit 20 generates a block carry BC and a carry input CIN based on the carry generation signal GG and the carry propagation signal PP. The carry generating unit 20 includes N leaf-cells that are grouped as will be explained below with reference to FIG. 2. The group bypassing unit 30 generates a carry output COUT based on the carry propagation signal PP and the block carry BC. The summing unit 40 generates an N-bit sum output based on the carry propagation signal PP and the carry input CIN.

The carry generation signal GG is a result of an AND operation of the two inputs as formulated by Expression 1:

GG=Xi*Yi, (1)

where, Xi and Yi are two inputs, and “*” denotes an AND operation.

The carry propagation signal PP is a result of an Exclusive OR operation of the two inputs as formulated by Expression 2:

PPi=Xi ⊙ Yi, (2)

where “⊙” denotes an Exclusive OR operation.

A sum output SOUT is a result of an operation as formulated by Expression 3:

SOUTi=Xi ⊙ Yi ⊙ CINi. (3)

FIG. 2 is a diagram illustrating leaf-cells in the carry generating unit 20 and block leaf-cells in the group bypassing unit 30 of the conditional selection adder 100 of FIG. 1, according to an example embodiment of the present invention. FIG. 2 illustrates an operation of the conditional selection adder 100 of FIG. 1 when two 32-bit inputs are provided.

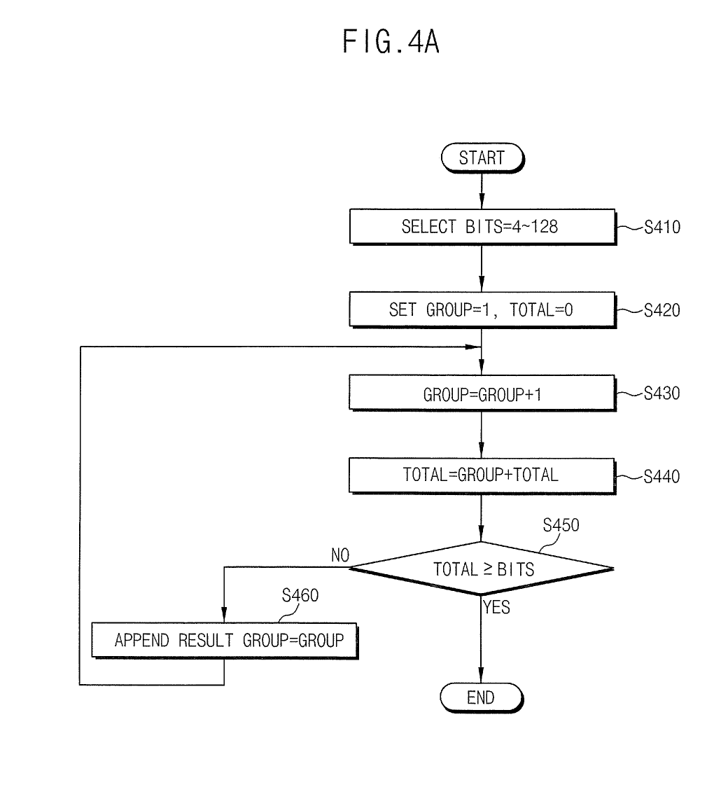

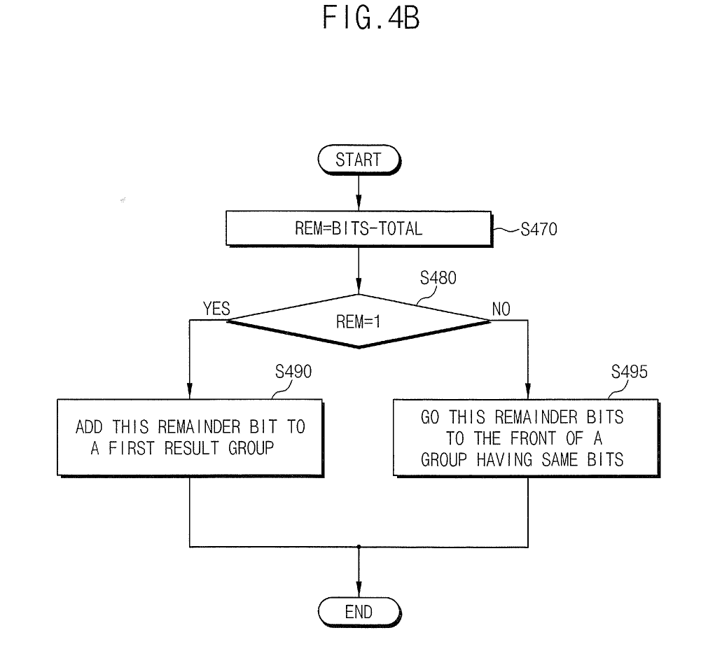

Referring to FIG. 2, the carry generating unit 20 includes leaf-cells LC0 through LC31. Accordingly, the carry generating unit 20 includes the thirty-two leaf-cells. Each of the leaf-cells receives the carry generation signal PPi and the carry propagation signal GGi that are generated based on the two inputs. Thus, LC0 receives GG0 and PP0, and LC1 receives GG1 and PP1. The thirty-two leaf-cells LC0 through LC31 are grouped by a first method. A number of the leaf-cells in each group increases in ascending order from a first group that includes the smallest number of the leaf-cells to a last group that includes the largest number of the leaf-cells. In FIG. 2, a fourth group G4 includes the same number of leaf-cells as the number of leaf-cells in a fifth group G5. In this case, the fifth group G5 corresponds to a remainder group. The number of the leaf-cells in each group generally increases by one from the first group to the last group. A remainder group includes remainder leaf-cells that are not grouped by the ascending order because the number of the remainder leaf-cells is not greater than the number of the leaf-cells in the last group. Thus, the remainder group is arranged according to the first method. The first method will be described below referring to FIGS. 4A and 4B.

Each leaf-cell LCi generates the carry input CINi to be provided to the next number leaf-cell based on the carry generation signal GGi and the carry propagation signal PPi. The last leaf-cell in each group receives the carry input CINi that is provided from the previous leaf-cell, the carry generation signal GGi, and the carry propagation signal PPi to generate a block carry BCj.

The block carry BCj signals are generated at each of the last leaf-cells in each group and are provided to the block leaf-cell. The last leaf-cells LC1, LC4, LC8, LC13, LC18, LC24 and LC31 in each group respectively provide the block carry BCj to the bock leaf-cells BLC1, BLC2, BLC3, BLC4, BLC5, BLC6 and BLC7 in FIG. 2. The bypassing unit 30 generates an output carry based on the block carry BCj that are transmitted to the block leaf-cells in the bypassing unit 30 and based on the carry propagation signal PPi.

The bypassing unit 30 includes the block leaf-cells as many as a number of the groups that are included in the carry generating unit 20, as illustrated in FIG. 2. Although not illustrated in FIG. 2, the input carry signals CINi that are generated at the leaf-cells LC0 through LC31 in the carry generating unit 20 are provided to the summing unit 40, which performs an additional operation on the two inputs to generate the sum output SOUT.

A maximum gate delay occurs in a seventh group G7 that includes a maximum number of leaf-cells in FIG. 2. Here, a first gate delay for the block carry BC corresponds to a number of gates that the carry generation signal GGi and the carry propagation signal PPi pass through until the block carry BCi are provided to the block leaf-cells. Accordingly, the first gate delay corresponds to the number of the leaf-cells in the last group that includes the maximum leaf-cells in the carry generating unit 20. The first gate delay corresponds to seven in FIG. 2 because the seventh group G7 includes the seven leaf-cells corresponding to the maximum leaf-cells.

A second gate delay for the output carry COUT corresponds to a number of gates that the carry generation signal GGi and the carry propagation signal PPi pass through until the output carry COUT is generated. Accordingly, the second gate delay corresponds to nine, which is eight plus one, because the number of the gates is calculated based on numbers [1] through [8] that are marked as arrows when the carry generation signal GG0 and the carry propagation signal PP0 are inputted to the leaf-cell LC0 in the first group G1, in FIG. 2. The second gate delay corresponds to nine when the carry generation signal GG3, GG5 and GG9, and the carry propagation signal PP3, PP5 and PP9 are inputted to the leaf-cells LC3, LC5 and LC9 of a second group G2, a third group G3 and the fourth group G4 respectively. The second gate delay corresponds to eight, which is seven plus one, because the number of the gates is calculated based on numbers (1) through (7) that are marked as arrows when the carry generation signal GG14, and the carry propagation signal PP14 are inputted to the leaf-cell LC14, in FIG. 2. The second gate delay corresponds to eight when the carry generation signal GG19 and GG25, and the carry propagation signal PP19 and PP25 are inputted to the leaf-cells LC19 and LC25 in a sixth group G6 and the seventh group G7.

In FIG. 2, data skew corresponds to a difference between the first gate delay for the block carry BC from the leaf-cell LC25 to the block leaf-cell BLC 7 and the first gate delay for the block carry from the leaf-cell LC0 to the block leaf-cell BLC 7. Therefore, the data skew corresponds to one that is eight minus seven in FIG. 2. The gate delay of eight is calculated based on the numbers [1] through [8] and the gate delay of seven is calculated based on the numbers (1) through (7). An operation speed of an adder is faster as a data skew is decreased. Therefore, the data skew may be a measuring factor of the operation speed of the adder.

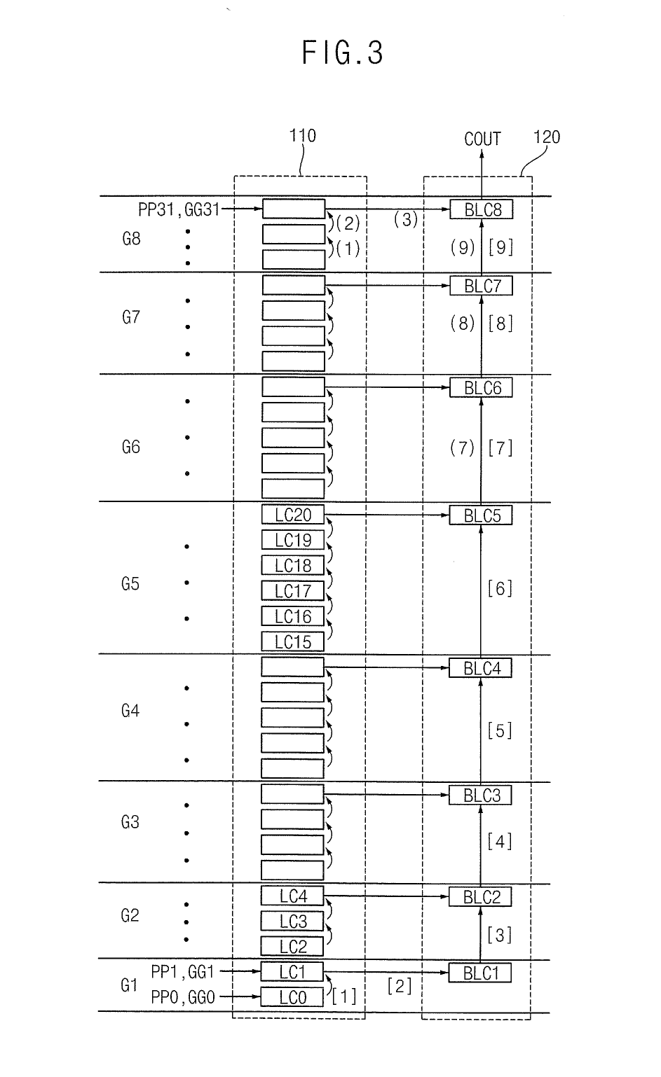

FIG. 3 is a diagram illustrating leaf-cells in a carry generating unit 110 and block leaf-cells in a group bypassing unit 120 of an adder that are to be compared with the conditional selection adder of FIG. 1. In FIG. 3, although a carry signal generation unit and a summing unit are not illustrated, the carry signal generation unit and the summing unit are same as the carry signal generation unit 10 and the summing unit 40 of FIG. 1. In FIG. 3, the leaf-cells are grouped using a second method. FIG. 3 illustrates an operation of another adder when two 32-bit inputs are provided.

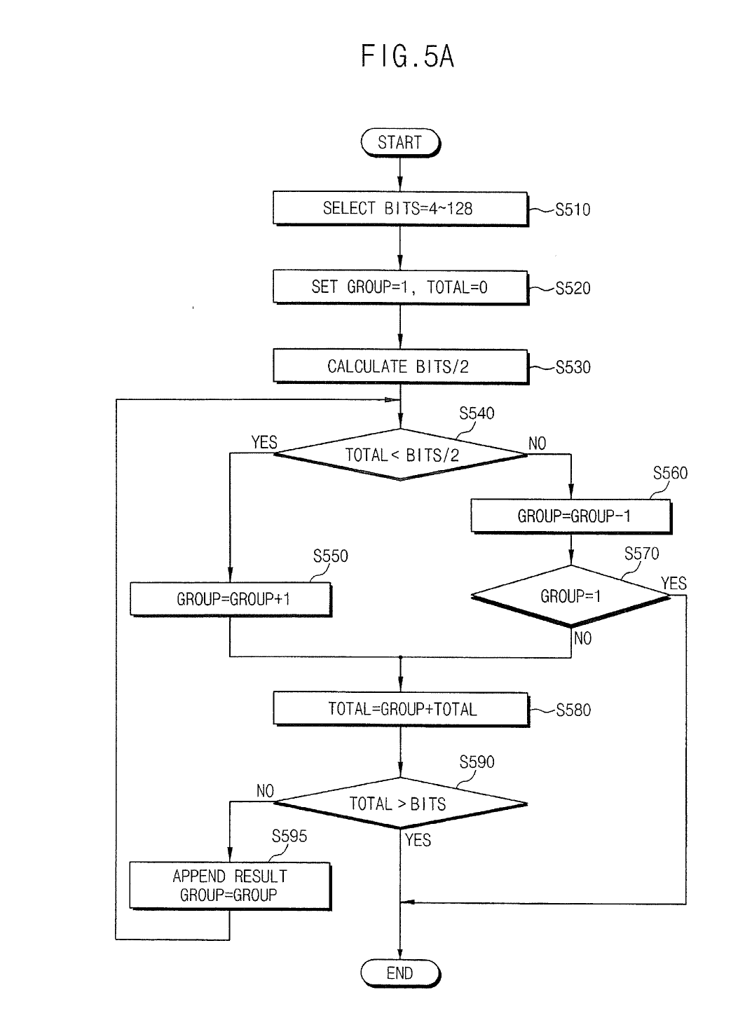

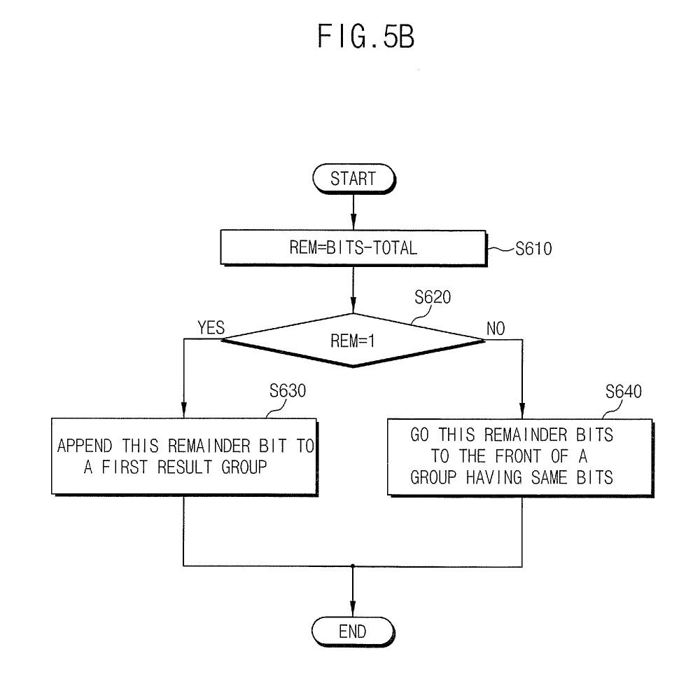

Referring to FIG. 3, the carry generating unit 110 includes 8 groups G1 through G8. Numbers of the leaf-cells in each group are 2, 3, 4, 5, 6, 5, 4, and 3 respectively. Therefore, the leaf-cells are grouped in ascending order and then in descending order. The second method will be described in detail with reference to FIG. 5A and FIG. 5B.

An operation of the adder in FIG. 3 is similar to an operation of FIG. 2, and the detailed description is omitted. A first gate delay for a block carry BC occurs in a fifth group G5 that includes the maximum number of leaf-cells. The first gate delay corresponds to six because the fifth group G5 includes six leaf-cells that are the maximum number of leaf-cells among the groups in FIG. 3. A second gate delay for an output carry COUT corresponds to ten that is nine plus one because a number of gates is calculated based on numbers [1] through [9] that are marked as arrows. A data skew corresponds to six that is nine minus three in the adder of FIG. 3. The gate delay nine is calculated based on the numbers [1] through [9] and the gate delay three is calculated based on numbers (1) through (3). Therefore, the first gate delay for the block carry BC of FIG. 3 corresponds to six and the first gate delay for the block carry BC of FIG. 2 corresponds to seven. Additionally, the data skew that is calculated using the second method of FIG. 3 corresponds to six and the data skew that is calculated using the first method of FIG. 2 corresponds to one. As a result, the conditional selection adder 100 that includes the carry generating unit 20 and the group bypassing unit 30 of FIG. 2 may operate faster than the adder that includes the carry generating unit 120 and the group bypassing unit 130 of FIG. 3.

FIG. 4A is a flow chart illustrating how the leaf-cells are grouped in the carry generating unit 20 in FIG. 2, and FIG. 4B is a flow chart illustrating how a remainder group, which includes the remainder leaf-cells, is arranged in the carry generating unit 20 in FIG. 2. Referring to FIG. 4A, a number of bits of the two inputs is selected (Step S410). A group value is set as one and a total value is set as zero (Step S420). Additionally, the group value is updated to a value that is the previous group value plus one (Step S430). Thus, the number of the leaf-cells in each group increases in ascending order from the first group to the last group. Next, the total value is updated to a value that is the previous total value plus the group value (Step S440). Here, the total value is compared with the number of the bits that are selected at Step S410 (Step S450). A result group value is set as the group value (Step S460) and the group value is updated to a value that is the previous group value plus one (Step S430) when the total value is smaller than the number of the bits. All steps are finished when the total value is over the number of the bits.

Referring to FIG. 4B, a remainder value REM, which is the number of leaf-cells of the remainder group, is set as a value that is the number of the bits minus the total value that is set at Step S440 (Step S470). Here, the remainder value REM is the number of the leaf-cells that are not grouped using the steps of FIG. 4A. The remainder value REM is compared with one (Step S480). The remainder group that includes the one leaf-cell is arranged at a first position of the groups when the remainder value is one (Step S490). The remainder group that includes the leaf-cells greater than one is arranged in front of a group that includes leaf-cells as many as the remainder value (Step S495). In the example of FIG. 2, the remainder group G4 that includes five leaf-cells is arranged in front of a fifth group G5 that includes five leaf-cells because the remainder value is five when two 32-bit inputs are selected as inputs.

FIG. 5A is a flow chart illustrating how the leaf-cells are grouped in the carry generating unit 120 in FIG. 3, and FIG. 5B is a flow chart illustrating how a remainder group including the remainder leaf-cells is arranged in the carry generating unit in FIG. 3 for comparing the adder of FIG. 3 with the conditional selection adder of FIG. 2 according to an example embodiment of the present invention. Referring to FIG. 5A, the number of bits of the two inputs is selected (Step S510). A group value is set as one and a total value is set as zero (Step S520). Additionally, the number of bits is divided by two (Step S530). Next, the total value is compared with a value that is calculated at Step S530 (Step S540). Here, the group value is updated to a value that is the previous group value plus one when the calculated value is over the total value (Step S550), and the group value is updated to a value that is the previous group value minus one when the calculated value is smaller than the total value (Step S560). The group value that is calculated at step S560 is compared with one (Step S570). All steps are finished when the group value is one. Additionally, the total value is updated to a value that is the group value plus the previous total value when the group value is grater than one and when Step S550 is finished (Step S580). Next, a result group value is set as the group value (Step S595) and Step S540 follows Step S595, when the total value is smaller than the number of the bits. All steps are finished when the total value is greater than the number of the bits.

Referring to FIG. 5B, a remainder value is set as a value that is the number of the bits minus the total value that is set up at Step S580 (Step S610). Here, the remainder value is the number of the leaf-cells that are not grouped using steps of FIG. 5A. The remainder value is compared with one (Step S620). A remainder group that includes one leaf-cell is arranged in front of the first group when the remainder value is one (Step S630). The remainder group that includes leaf-cells more than one is arranged in front of a group that includes leaf-cells as many as the remainder value and that is grouped in descending order (Step S640). In the example of FIG. 3, the remainder value is zero because the total value at Step S580 is thirty-two and the number of the bits is thirty-two.

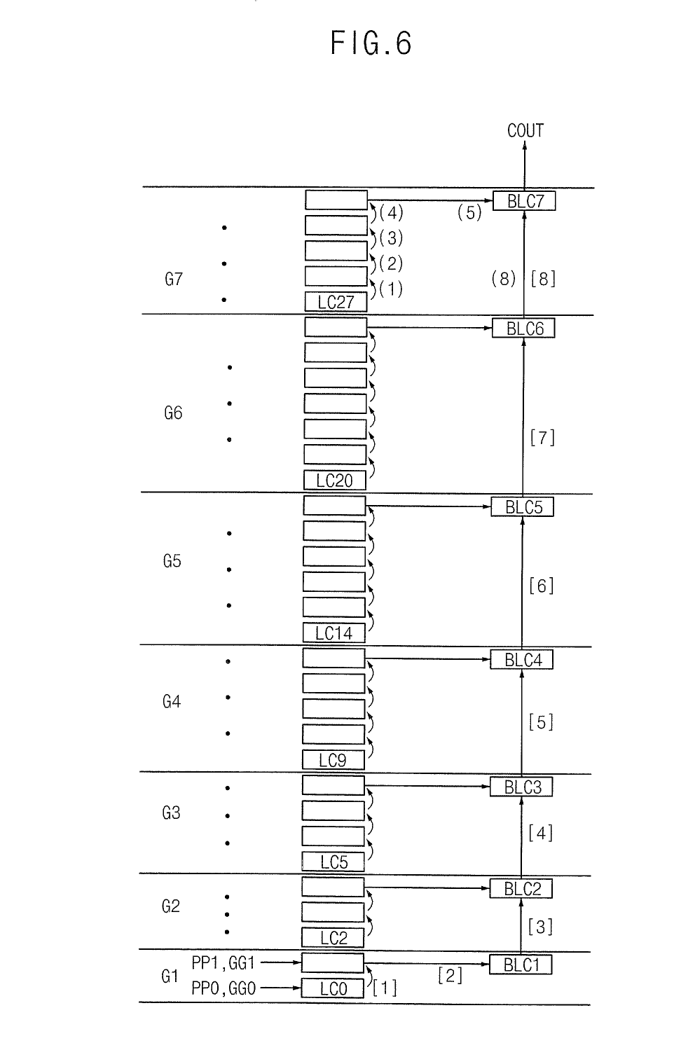

FIG. 6 is a diagram illustrating leaf-cells in a carry generating unit and block leaf-cells in a group bypassing unit of an adder, in which a remainder group that includes remainder leaf-cells is arranged next to the last group, that are to be compared with the conditional selection adder of FIG. 1. Referring to FIG. 6, a first gate delay for a block carry BC occurs at a sixth group G6 that includes a maximum number of leaf-cells. The first gate delay corresponds to seven because the sixth group G6 includes seven leaf-cells that are the maximum leaf-cells, in FIG. 6. A second gate delay for an output carry COUT corresponds to nine that is eight plus one because the number of gates is calculated based on numbers [1] through [8] that are marked as arrows. A data skew corresponds to three that is eight minus five, in FIG. 6. A gate delay eight is calculated based on numbers [1] through [8] and a gate delay five is calculated based on numbers (1) through (5). Therefore, the data skew that is calculated using a third method as described with respect to FIG. 6 is larger than the data skew that is calculated using the first method of FIG. 2. Here, the remainder group is arranged based on the steps of FIG. 4B.

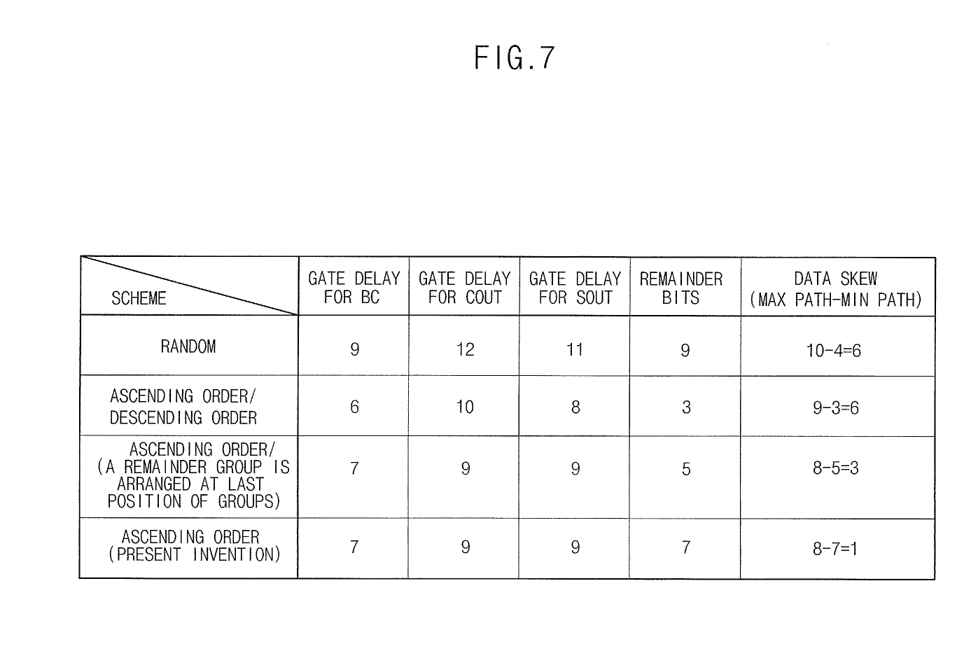

FIG. 7 is a table illustrating a comparison result of a first gate delay for a block carry BC, a second gate delay for a carry output COUT, a third gate delay for a sum output SOUT, and a data skew, when leaf-cells in a carry generating unit are grouped using various methods. The methods include a random grouping method, an ascending/descending grouping method of FIG. 3, a first ascending grouping method of FIG. 6, and a second ascending grouping method of FIG. 2. A remainder group that includes remainder leaf-cells is arranged next the last group according to the first ascending method, and a remainder group that includes remainder leaf-cells is arranged based on the steps of FIG. 4B according to the second ascending method.

The numbers of the leaf-cells in each group are 2, 4, 3, 5, 9, 4, and 5 according to the random grouping method of FIG. 7. The third gate delay for the sum output SOUT corresponds to the number of gates that exist after two inputs are inputted until the sum output SOUT is outputted. Therefore, the third gate delay for the sum output SOUT is the first gate delay for the block carry BC plus two.

The data skew associated with a difference between carry propagation speeds is an important factor that determines an operation speed of an adder. The remainder leaf-cells in the remainder group are arranged in a particular position of the groups in the conditional selection adder according to the ascending grouping method. Additionally, the conditional selection adder of FIG. 1 according to an example embodiment of the present invention has the smallest data skew among other adders of FIG. 3 and FIG. 6.

As mentioned above, a conditional selection adder and a method of conditional selection adding may reduce a data skew by grouping leaf-cells in a carry generating unit to arrange groups in ascending order and to arrange a remainder group at a particular position. Accordingly, a high performance may be achieved and the operation speed may be improved without increasing an area of the adder.

While the example embodiments of the present invention and their advantages have been described in detail, it should be understood that various changes, substitutions and alterations may be made herein without departing from the scope of the invention.

1. A conditional selection adder, comprising:
a first signal generator configured to generate a carry generation signal and a carry propagation signal in response to a pair of operands to be added;
a second signal generator configured to generate a carry input signal and a block carry signal in response to the carry generation signal and the carry propagation signal, said second signal generator comprising a plurality of groups of leaf-cells arranged in ascending order from a first group containing the fewest number of leaf-cells to a second group containing a largest number of leaf-cells; and
a summation circuit configured to generate a sum of the pair of operands in response to the block carry signal, the carry propagation signal and the carry input signal.

2. The adder of claim 1, wherein said summation circuit comprises a group bypass circuit configured to generate a carry output signal in response to the block carry signal and the carry propagation signal.

3. The adder of claim 2, wherein said summation circuit further comprises a summation unit configured to generate a summation output signal in response to the carry input signal and the carry propagation signal; and wherein the summation output signal and carry output signal collectively represent the sum of the pair of operands.

4. The adder of claim 1, wherein each of the leaf-cells in the plurality of groups of leaf-cells is responsive to corresponding bits of the carry generation and carry propagation signals.

5. The adder of claim 4, wherein a most significant leaf-cell in each of the plurality of groups of leaf-cells is configured to generate a corresponding bit of the block carry signal.

6. The adder of claim 2, wherein each of the leaf-cells in the plurality of groups of leaf-cells is responsive to corresponding bits of the carry generation and carry propagation signals.

7. The adder of claim 6, wherein a most significant leaf-cell in each of the plurality of groups of leaf-cells is configured to generate a corresponding bit of the block carry signal.

8. The adder of claim 7, wherein said group bypass circuit comprises a plurality of leaf-cells therein that are each configured to receive a corresponding bit of the block carry signal.

9. The adder of claim 1, wherein the second group is a last group.

10. The adder of claim 1, wherein the second group is an intermediate group; and wherein a last one of the plurality of groups of leaf-cells has a fewer number of leaf-cells therein relative to the intermediate group.

11. A conditional selection adder, comprising:
a carry signal generating unit configured to generate a carry generation signal and a carry propagation signal in response to two N-bit inputs, N being a natural number;
a carry generating unit configured to generate a carry input and a block carry in response to the carry generation signal and the carry propagation signal, the carry generating unit including at least one group that respectively includes at least one leaf-cell, a number of the leaf-cells in each group increasing in ascending order from a first group that includes a smallest number of leaf-cells to a last group that includes a largest number of leaf-cells;
a group bypassing unit configured to generate a carry output in response to the carry propagation signal and the block carry; and
a summing unit configured to generate a sum output that is an addition result of the two N-bit inputs in response to the carry propagation signal and the carry input.

12. The conditional selection adder of claim 11, wherein the number of the leaf-cells in the first group of the carry generating unit corresponds to two.

13. The conditional selection adder of claim 12, wherein the number of the leaf-cells in the each group increases by 1 in ascending order from the first group to the last group before a total sum T of the numbers of the leaf-cells in all groups from the first group to the last group exceeds N.

14. The conditional selection adder of claim 13, wherein a remainder group including M leaf-cells, in which M corresponds to T subtracted from N, is arranged at a first position of the groups when M corresponds to one.

15. The conditional selection adder of claim 14, wherein the remainder group is arranged in front of a group that includes leaf-cells as many as M when M is greater than one.

16. The conditional selection adder of claim 15, wherein the group bypassing unit includes leaf-cells as many as numbers of the groups included in the carry generating unit.

17. The conditional selection adder of claim 16, wherein last leaf-cells in the each group provides the block carries to the each leaf-cell in the group bypassing unit.

18. The conditional selection adder of claim 11, wherein the carry generation signal corresponds to a result of an AND operation of the two inputs.

19. The conditional selection adder of claim 11, wherein the carry propagation signal corresponds to a result of an Exclusive OR operation of the two inputs.

20. The conditional selection adder of claim 19, wherein the sum output of the summing unit corresponds to a result of an Exclusive OR operation of the carry propagation signal and the carry input.

21.-30. (canceled)
